(19) United States
(12) Patent Application Publication
(10) Pub. No.: US 2019/0207272 A1
(43) Pub. Date: Jul. 4, 2019

(54) SYSTEM AND METHOD FOR BATTERY CHARGING

(71) Applicant: Walmart Apollo, LLC, Bentonville, AR (US)

(72) Inventors: John J. O'BRIEN, Farmington, AR (US); Samantha M. MANGOSING, Bella Vista, AR (US); Brian MCHALE, Oldham (GB); David WINKLE, Bella Vista, AR (US)

(73) Assignee: Walmart Apollo, LLC, Bentonville, AR (US)

(21) Appl. No.: 16/226,334

(22) Filed: Dec. 19, 2018

Related U.S. Application Data
(60) Provisional application No. 62/611,752, filed on Dec. 29, 2017.

(51) Int. Cl. H01M 10/44; H02J 7/00; H01M 10/613; H01M 10/6556

(52) U.S. Cl. CPC H01M 10/443; H02J 7/0045; H01M 10/6556; H02J 7/007; H01M 10/613; H02J 7/0021

(57) ABSTRACT

A battery charging system includes an enclosure unit having one or more chambers therein. Each of the chambers houses one or more batteries to be charged, and includes a modular connection that connects to charging ports of the batteries. The system also includes a cooling unit configured to cool down the batteries to a preferred charging temperature range, a display unit configured to display information on charging status of the batteries, and a control unit configured to automatically control charging of the batteries. The control unit is in communication with the display unit to provide the information on the charging status.

### CROSS-REFERENCE TO RELATED APPLICATIONS

This application claims priority to U.S. Provisional Patent Application No. 62/611,752, filed Dec. 29, 2017, the contents of which are incorporated herein in their entirety.

### BACKGROUND

### 1. Technical Field

The present disclosure relates to battery technology. More specifically, the present disclosure relates to systems and methods for battery charging.

### 2. Introduction

Rechargeable batteries, such as the batteries used for drones or unmanned aerial vehicles (UAV), may require a cooling system to bring the battery's core to an optimal temperature for off-duty or on-duty charging. If the battery charges in a temperature range outside of its best operating condition, it can increase the degradation rate of battery life as well as harm the internal components of the battery.

What is needed are systems and methods for battery charging that enable the quick and efficient cooling of the battery a preferred temperature range prior to and during the battery charging.

### SUMMARY

Disclosed herein are systems for battery charging, which overcome at least some drawbacks known in the art. An example system for battery charging may include an enclosure unit having one or more chambers therein. Each of the chambers may house one or more batteries to be charged. Each of the chambers may include a modular connection that connects to charging ports of the batteries. The modular connection may be interchangeable for different battery connectors. A power supply may be connected to the modular connection. The system may also include a cooling unit configured to cool down the batteries to a charging temperature range. The cooling unit can be in fluid communication with the enclosure unit. The system may further include a display unit configured to display information on charging status of the batteries. The display unit may be on an outside of the enclosure unit. The system may also include a control unit configured to automatically control charging of the batteries. The control unit is in communication with the power supply and the display unit to provide the information on the charging status. The control unit receives parameters of the batteries and charging parameters to determine charging time of the batteries.

An exemplary method for charging a battery is also disclosed herein. The method may include allocating the battery to one chamber inside an enclosure unit. The enclosure unit may have one or more chambers therein, and each of the chambers may house one or more batteries to be charged. The method may also include receiving parameters of the battery and charging parameters; cooling the battery based on the parameters of the battery, by a cooling unit, down to a preferred charging temperature range; and automatically charging the battery based on the parameters of the battery and the charging parameters, when the preferred charging temperature range is reached. The charging may be controlled via a control unit. The method may further include optimizing the charging of the battery based on optimizing parameters; and displaying, on a display unit, information on charging status of the battery. The control unit monitors the charging of the battery, and is in communication with the display unit to provide the information on the charging status.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Embodiments of this disclosure are illustrated by way of an example and not limited in the figures of the accompanying drawings, in which like references indicate similar elements and in which:

FIG. 1 illustrates a perspective view of an example system for battery charging according to one example embodiment;

FIG. 2 illustrates another perspective view of the example system of FIG. 1 according to one example embodiment;

FIG. 3 illustrates an example display unit of the example system of FIG. 1 according to an example embodiment;

FIG. 4 illustrates a block diagram of an example logic connection flow of the system of FIG. 1 according to one embodiment;

FIG. 5 illustrates a block diagram of an example logic flow of information display for the system of FIG. 1 according to one embodiment;

FIG. 6 illustrates a block diagram of a logic flow of example ongoing battery status updates for the system of FIG. 1 according to one embodiment;

FIG. 7 illustrates a block diagram of a logic flow of example shutting off of a battery charging for the system of FIG. 1 according to one embodiment;

FIG. 8 illustrates a block diagram of a logic flow of an example cooling shutting-off for the system of FIG. 1 according to one embodiment;

FIG. 9 illustrates an example enclosure having a plurality of individual chambers according to one embodiment;

FIG. 10 illustrates an example method for charging a battery; and

FIG. 11 illustrates an example computer system which can be used to implement the systems and methods for index search engine according to one example embodiment.

### DETAILED DESCRIPTION

Various configurations and embodiments of the disclosure are described in detail below. While specific implementations are described, it should be understood that this is done for illustration purposes only. Other components and configurations may be used without parting from the spirit and scope of the disclosure.

Batteries in, for example drones, can become heated during use. To cool down the batteries, a portable air conditioner (A/C) unit, or simply a fan to blow over the batteries, can be used to pre-chill the batteries in order to get them charged effectively. But such an approach can take up to an hour, or even longer, to bring the battery to a preferred charging temperature. Systems and methods disclosed herein can quickly cool the battery to a preferred temperature or a preferred temperature range at which the battery can be recharged. The methods and systems provided herein are able to reduce a cooling time from several hours using current methods to, for example, three or five minutes or even less. This can cool the battery down much quicker for recharging. With such systems and methods, batteries may be hot-swapped out quicker, for example, for drones or UAVs, such that more flights or trips can be performed. Further, a system is also needed to monitor the batteries' charging parameters accurately, which can be fulfilled by the systems disclosed herein.

In addition, the systems and methods disclosed herein are also applicable to batteries for ground vehicles (e.g., battery powered electric or hybrid vehicles), laptops, smart devices, power storage banks, etc. Further, the disclosed systems may incorporate a heat exchanger to use the waste heat from the batteries for other purposes. The waste heat could also be used in a heat engine or electrochemical cell to help to power the system.

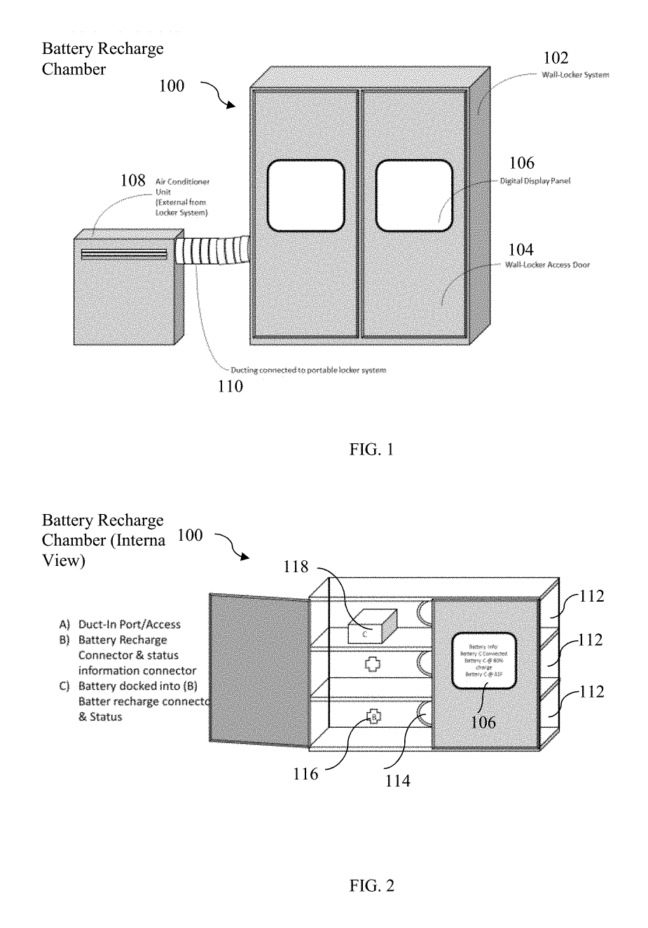

FIG. 1 illustrates a perspective view of an example system 100 for battery charging. As shown in FIG. 1, the system 100 may also be referred to as a battery recharge chamber system and may include an enclosure 102 (also referred to as a wall-locker system) inside which one or more batteries are housed for charging. The enclosure 102 may be portable, and include one or more access doors 104, for example, for putting in and taking out the batteries. The system 100 may also include a digital display unit 106, for example, for displaying information on the charging status of the batteries. The system 100 may further include a cooling unit 108 (e.g., an air conditioner that may be portable) for cooling down the batteries prior to and during the battery charging. The cooling unit 108 may be external to the enclosure 102. The cooling unit 108 may be removably connected to the enclosure 102, for example, via ducting 110.

The enclosure 102 may include a material that can provide protection in case of an accident during the re-charging periods. For example, a material that can contain a lithium polymer explosion, for example, if the batteries to be charged are lithium-based batteries. That material may be applied to a casing around the outside of the enclosure. The enclosure 102 or a portion of the enclosure 102 may also be made of a steel such as a stainless steel.

The display unit 106 may be positioned outside of the enclosure 102, for example embedded, built into, or attached to the access door 104 of the enclosure 102. The display unit 104 can be any digital or electronic display unit. In some embodiments, the display unit 104 may be a standalone display unit, for example a liquid crystal display (LCD) unit that can be positioned on top or side of the enclosure 102.

The cooling unit 108 may be a gas-based cooling unit (such as an air conditioner), a liquid-based cooling unit, or a combination thereof. The coolant of the cooling unit 108 may be air for a gas-based unit, or water or liquid nitrogen for a liquid-based unit. The cooling unit 108 may be a standalone unit positioned outside the enclosure 102, or may be in fluid communication with the enclosure 102, and positioned, for example inside an open container fixed to a side wall of the enclosure 102.

The ducting 110 may be made of any materials suitable for coolant delivery, as known in the art. The ducting 110 may include one or more ducts that are attached to a wall of the enclosure 102, through which the coolant is transported into the enclosure 102 to cool down the batteries.

An internal perspective view of the example system 100 is illustrated in FIG. 2 according to one example embodiment. As shown in FIG. 2, the enclosure 102 may include one or more chambers 112 therein. Chambers 112 may be separate from each other. Each of the chambers 112 may house one or more batteries 118 to be charged. Each chamber 112 may be configured to have at least one port or access 114 that is used to receive coolant into the chamber, for example via ducting 110.

Each of the chambers 112 may also include a modular connection that may connect to the charging ports and other connectors of the batteries. The modular connection may also include different types of connectors 116 (e.g., a battery recharge connector and a status information connector.) The modular connection may also be connected to a power supply for charging the batteries. The modular connection can be interchangeable for different types of connectors for communicating with the display unit 106 to provide information on battery and battery charging, and other information, as well as to receive control signals to automatically control the battery charging. In some embodiments, the battery recharge connector and the status information connector may be separate from one another. The battery recharge connectors and the status information connectors, and also other connectors, may be integrated with and built into the chambers 112 or the enclosure 102. An example battery 118 is illustrated docked into one battery recharge connector and status information connector 116.

The system 100 may also include a control unit configured to automatically control charging of the batteries via the battery recharge connectors and status information connectors by sending control signals to and receiving feedback signals from the batteries. The control unit may monitor charging parameters of the batteries. The charging parameters may include charging rate, charging time, charging capacity, charging temperature, etc. For example, the parameters may be information on a battery or batteries charging status, information on a battery or batteries temperature, information on a battery or batteries core status, information on the voltage and amperage going into a battery, information on the temperature inside the chambers and the ambient temperatures outside the chambers and enclosure, and information on alerts or messages on charging status, temperature, core information, etc. The information on the charging status may include a charging rate, how long a battery has been charged, how much capacity of the battery has been charged, a voltage and an amperage going into the battery, a current temperature of the battery, and an expected time for completing charging the battery. The information on the charging status may also include charging status updates and alerts. The information on the batteries may include a maximum capacity of the battery, a preferred charging rate, a preferred charging temperature, and a degraded degree of the battery. The control unit may be in communication with the power supply, and may receive the parameters of the batteries and the charging parameters to determine charging time of the batteries.

For example, the control unit may send signals to stop or slow down charging a battery when the battery reaches its maximum capacity. The control unit can be in communication with the display unit 106 to provide the information on the charging status.

The control unit may be further configured to send control signals to automatically shut off or reduce coolant delivery from the cooling unit 108 to the one or more of chambers 112 when the preferred charging temperature range in the one or more chambers is reached, for example, by fully or partially shutting off one duct of the ducting 110 corresponding to the one chamber for that battery. The control unit may be further configured to control a flow rate of coolant from the cooling unit 108 going into each of the chambers 112. For example, the control unit may control mechanisms to regulate a degree of opening of valves that are positioned inside each duct corresponding each chamber, based on, for example a current temperature of the batteries inside the chamber, how close the current temperature is to the preferred temperature or temperature range of the batteries, and a cooling rate of the batteries (i.e., how fast the temperature drops). The valves may include, but are not limited, ball values, solenoid valves, plug valves, gate valves, butterfly valves, global valves, pinch valves, and/or check valves.

In some embodiments, a chamber of the enclosure 102 may include one or more cooling plates that are configured to directly contact the batteries inside the chamber to facilitate cooling the batteries down to the preferred charging temperature. The cooling plate may be configured to have one or more fluid channels in which, for example water or another substance as the coolant, may circulate. The water may be pumped by a water pump of the cooling unit 108.

The system 100 may also include one or more temperature sensors to measure, detect, and monitor the temperatures of the batteries inside the enclosure 102 and/or the temperatures inside the chambers 112. The temperature sensors can be any type of temperature sensors known in the art, and may be disposed inside the chambers 112 or inside the batteries. For example, a sensor inside a battery may be used to determine a present temperature of the battery's core. The battery can provide that temperature information via a status information connector 116. Then the temperature information can further be provided to the display unit 106 for display and to the control unit, for controlling charging the battery.

In some embodiments, the system 100 may include a binary language system for the control unit to communicate with the batteries. The system 100 may also include a binary-language processing system for converting binary codes to language to be displayed on the display interface unit 106. The binary language system and the binary-language processing system can be combined with and built into the control unit, or the battery or batteries. The binary language system and the binary-language processing system can also be standalone systems (referred to as a binary language unit) that are configured to communicate with the control unit.

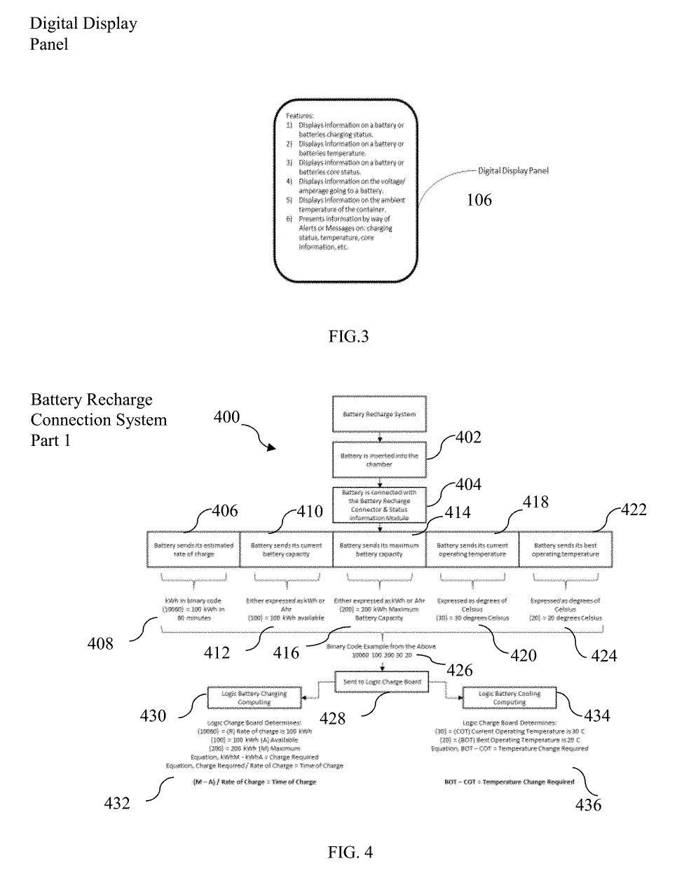

An example display unit 106 is illustrated in FIG. 3 that can be used for displaying information of the batteries while they are in the chambers. As described above, the binary language unit is configured to facilitate controlling and monitoring the charging and cooling process of the batteries. The binary language unit may be configured to facilitate displaying on the display unit 106 the information regarding the charging status of the batteries, the cooling process of the batteries, and other information on the batteries. As shown in FIG. 3, the information displayed on the display unit 106 may include, but is not limited to, information on a battery or batteries charging status, information on a battery or batteries temperature, information on a battery or batteries core status, information on the voltage and amperage going into a battery, information on the temperature inside the chambers and the ambient temperatures outside the chambers and enclosure, and information on alerts or messages on charging status, temperature, core information, etc. The information on the charging status may include a charging rate, how long a battery has been charged, how much capacity of the battery has been charged, a voltage and an amperage going into the battery, a current temperature of the battery, and an expected time for completing charging the battery. The information on the charging status may also include charging status updates and alerts. The information on the batteries may include a maximum capacity of the battery, a preferred charging rate, a preferred charging temperature, and a degraded degree of the battery.

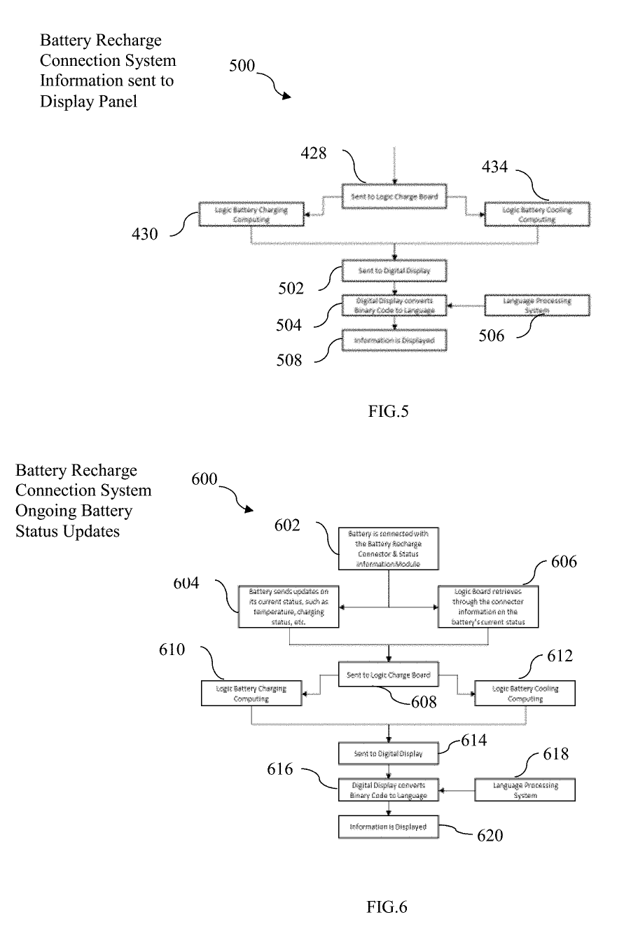

FIG. 4 illustrates a block diagram 400 of an example process. In block 402, one or more batteries are inserted into one or more corresponding chambers 112 of the enclosure 102. The batteries are then connected with the battery recharge connectors and status information connectors (block 404). After the connections, battery parameters may be determined. A battery may send to the control unit its estimated rate of charge (block 406), and the estimated rate of charge may be converted into a binary code or format via the binary language unit. For example, an estimated rate of charge may be 100 kWh and the corresponding binary code can be 10060 (block 408). The battery may also send to the control unit its current battery capacity (block 410), and the current battery capacity may be converted via the binary language unit to a binary code. The current battery capacity may be denoted as kWh or Ahr. For example, a current battery capacity may be 100 kWh and the corresponding binary code can be 100 (block 412). The battery may also send to the control unit its maximum battery capacity (block 414), and the maximum battery capacity may be converted via the binary language unit to a binary code. The maximum battery capacity may be denoted as kWh or Ahr. For example, a maximum battery capacity may be 200 kWh and the corresponding binary code can be 200 (block 416). The battery may also send to the control unit its current operating temperature (block 418), and the current operating temperature may be converted via the binary language unit to a binary code. The current operating temperature may be denoted as Celsius or Fahrenheit. For example, a current operating temperature may be 30 degrees Celsius and the corresponding binary code can be 30 (block 420). The battery may further send to the control unit its preferred operating temperature (block 422). The preferred operating temperature may be converted via the binary language unit to a binary code. The preferred operating temperature may be denoted as Celsius or Fahrenheit. For example, a preferred operating temperature may be 20 degrees Celsius and the corresponding binary code can be 20 (block 424). The preferred temperature may be determined by a manufacturer of the battery or based on a profile of the battery (e.g., the battery usage history). A final binary code of the battery combining the binary codes of each respective category of parameters above can be obtained as 100601002003020 (block 426), which is then sent to the control unit (block 428) for further processing.

Once battery parameters are determined, charging parameters of the battery may be determined. The control unit may perform logic battery charging computing (block 430) based on the final binary code. For example, a charge required for the battery can be calculated from the maximum capacity of the battery and the currently available capacity of the battery. A time required to recharge or charge the battery to the maximum capacity can be determined from the charge required and the estimated rate of charge (i.e., the charge required divided by the estimated rate of charge) (block 432).

The control unit may also perform logic battery cooling (temperature change) computing (block 434) based on the received final binary code. For example, a temperature change required for the battery can be calculated from the current temperature of the battery and the preferred temperature of the battery. That is, the temperature change required for bring the current temperature to the preferred temperature is a difference between the current temperature to the preferred temperature (block 436).

Once the charging parameters of the battery are determined, the battery may be then charged based on the charging parameters. The charging of the battery is controlled by the control unit.

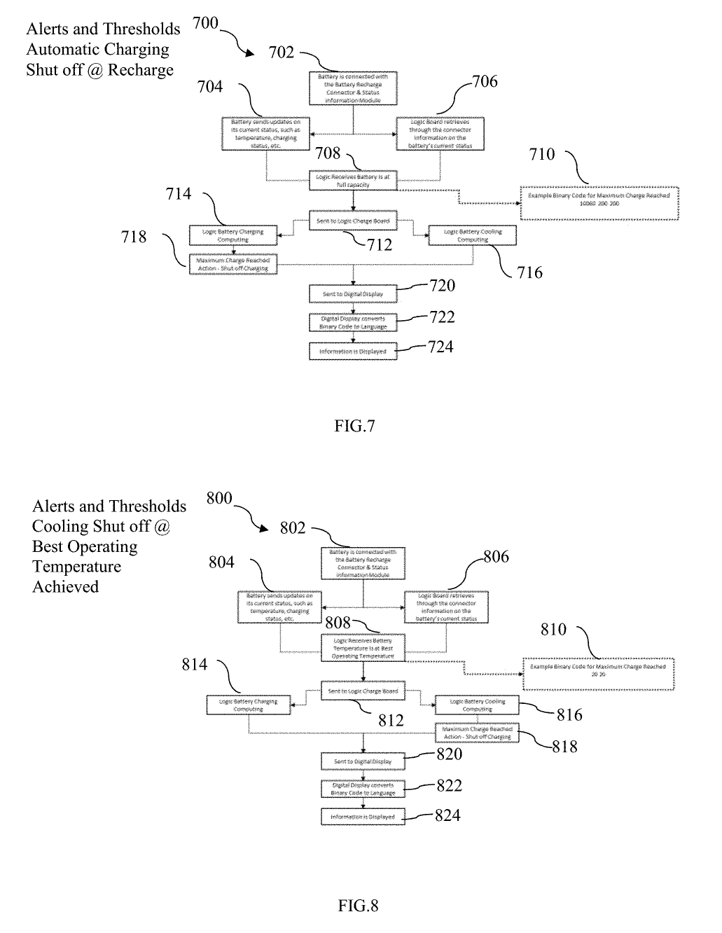

FIG. 5 illustrates a block diagram 500 of an example process according to one embodiment. After the battery information in the final binary code is further processed by the logic battery charging computing (block 430) and the logic battery cooling computing (block 434), the battery information is sent to the digital play unit 106 for display (block 502). Prior to displaying on the display unit 106, the binary code of the battery information may be converted to regular text language via the binary-language processing unit (blocks 504 and 506). The regular text is then displayed on the display unit 106 (block 508). The regular text can include the battery information for example, the estimated rate of charge, the present battery capacity, the maximum battery capacity, the present temperature, the preferred temperature, the required charge to reach the maximum capacity, the time required for charging the battery to the maximum capacity, and/or the temperature change required to cool the battery down to the preferred temperature.

FIG. 6 illustrates a block diagram 600 of a logic flow of example ongoing battery status updates for the system 100 according to one embodiment. After a battery is connected with a battery recharge connector and a status information connector (block 602), the battery may send to the control unit its current status, such as temperature, charging status, etc. (block 604). The control unit may also retrieve through the connectors information on the battery's current status (block 606). After the battery current information in a binary code is received by the control unit (block 608), the current information may further processed by the logic battery charging computing (block 610) and the logic battery cooling computing (block 612). The battery information is sent to the digital play unit 106 for display (block 614). Prior to displaying on the display unit 106, the binary code of the battery information may be converted to regular text language via the binary-language processing unit (blocks 616 and 618). The regular text is then displayed on the display unit 106 (block 620). The battery charging status is constantly updated via such communications between the battery and the control unit and the display unit 106.

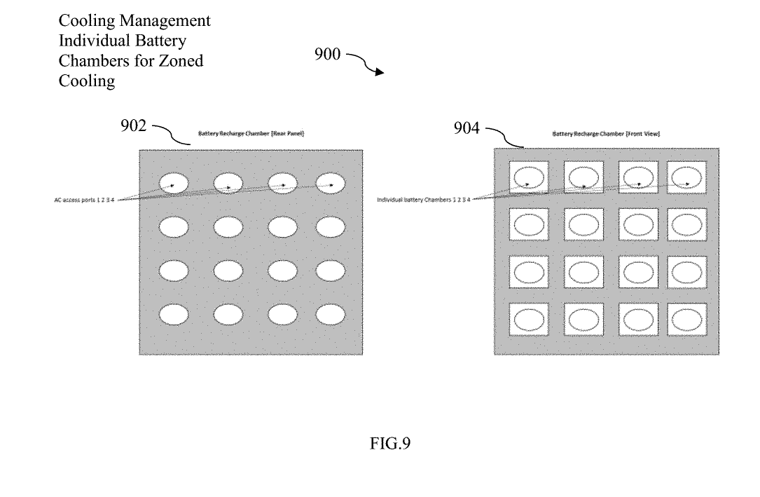

FIG. 7 illustrates a block diagram 700 of a process to stop charging according to one embodiment. At step 702, a battery is connected with a battery recharge connector and a status information connector and automatically starts charging. At step 704, the battery may send to the control unit its present status, such as temperature, charging status, etc. At step 706, the control unit may also retrieve through the connector information on the battery's present status. At step 708, the present information of the battery may indicate that the battery is at a full capacity. For example, at step 710, a binary code 10060200200 of the present information can indicate that the present capacity is 200 kWh which reaches the maximum capacity of 200 kWh at a charging rate of 100 kWh per 60 minutes. At step 712 the battery present information in the binary code is received by the control unit. At step 714, the present information may be further processed by the logic battery charging computing and the logic battery cooling computing (step 716). At step 718, the logic battery charging computing determines that the maximum charge capacity of the battery is reached and may signal to shut off the battery charging automatically. At step 720, the battery present information and shutting-off signal information is sent to the digital display unit 106 for display. Prior to displaying on the display unit 106, the binary code of the battery information and the shutting-off signal information may be converted to regular text language via the binary-language processing unit (step 722). The regular text is then displayed on the display unit 106 (step 724).

FIG. 8 illustrates a block diagram 800 of a logic for cancelling cooling according to one embodiment. After a battery is connected with a battery recharge connector and a status information connector (block 802) and automatically starts cooling down the battery, the battery may send to the control unit its present status, such as temperature, charging status, etc. (block 804). The control unit may also retrieve information on the battery's present status (block 806). At some time point, the present information may indicate that the battery is at its preferred operating temperature (block 808). For example, an example binary code 2020 (block 810) of the present information can indicate that the present temperature is 20 degrees Celsius which reaches the preferred temperature of 20 degrees Celsius. After the battery's present information in the binary code is received by the control unit (block 812), the present information may be further processed by the logic battery charging computing (block 814) and the logic battery cooling computing (block 816). The logic battery cooling computing determines that the preferred temperature is reached and may signal to shut off the battery cooling automatically (block 818). The battery's present information and shutting-off signal information is sent to the digital display unit 106 for display (block 820). Prior to displaying on the display unit 106, the binary code of the battery information and the shutting-off signal information may be converted to regular text language via the binary-language processing unit (block 822). The regular text is then displayed on the display unit 106 (block 824).

As described above, a system that uses a wall locker or enclosure that is connected to an external cooling unit, for example, through a ducting system to a portable air conditioner to cool the batteries in a wall locker chamber, is provided. The enclosure 102 may include one or more separate chambers to allow for multiple batteries to be charged, monitored, and cooled at the same time. Those chambers may be zoned such that each separate chamber's temperature and charging of the batteries is separately controlled. FIG. 9 illustrates an example enclosure 900 having a plurality of individual chambers according to one embodiment. As shown in FIG. 9, a rear view 902 of the example enclosure 900 shows a plurality of cooling duct access ports (e.g., AC access ports) corresponding to the plurality of individual chambers. That is, one individual chamber includes one duct access port for receiving a cooling duct to provide a coolant into the one individual chamber. A front view 904 of the example enclosure 900 shows the plurality of individual chambers with their corresponding cooling duct access ports. Each individual chamber may house one or more batteries for charging. In such a way, the charging and cooling of batteries can be separately controlled, monitored, and managed. The flow of coolant for each zone is also separately controlled. Status updates and alerts for each zone may also monitored and provided to a display unit separately.

In some embodiments, a confidence level system may be incorporated into the disclosed systems and methods in order to facilitate communications regarding the charging and cooling of batteries. In this context, the confidence levels may be used to determine whether a particular battery can be charged in an amount of time to support the next mission of, for example a drone. For example, a battery on a drone needs to be charged fully within one hour, such that the drone can fly in one hour for a scheduled next mission. Present parameters and requirements of the battery may be communicated to the disclosed system, for example, the present temperature of the battery, the preferred charging temperature of the battery, the present capacity of the battery, the maximum capacity of the battery, the preferred charging rate of the battery, required charging time (less than one hour) to the maximum capacity of the battery, etc. After receiving such parameters and requirements, the disclosed system may evaluate its capability to determine if it can meet the charging requirements based on the present parameters of the battery and its own capability. For example, the cooling unit of the disclosed system may be evaluated to determine if it can cool the battery quickly enough to the preferred charging temperature within a required cooling period of time. The control unit of the disclosed system may be evaluated to determine if it is capable of charging the battery fully within the required charging time. If the disclosed system is determined to be capable of meeting the charging requirements of the battery, a confidence level with a non-negative number may be assigned to the disclosed system. If the disclosed system is determined to be incapable of meeting the charging requirements of the battery, a confidence level with a negative number may be assigned to the disclosed system. One example of confidence level system can be: −1 unable to charging; 0 acceptable for charging; and +1 overly acceptable for charging.

Via the confidence levels, the disclosed system can also determine if an individual battery is able to maintain a charge long enough to complete a mission. The disclosed system may also use the confidence levels to facilitate pre-chilling the batteries before charging in order to optimize the time taken for charging.

In some embodiments, the disclosed systems may be able to identify each battery and maintain a history of charge/discharge for each one. This data can be used to evaluate the probability that a particular battery will be able to accept and hold a charge.

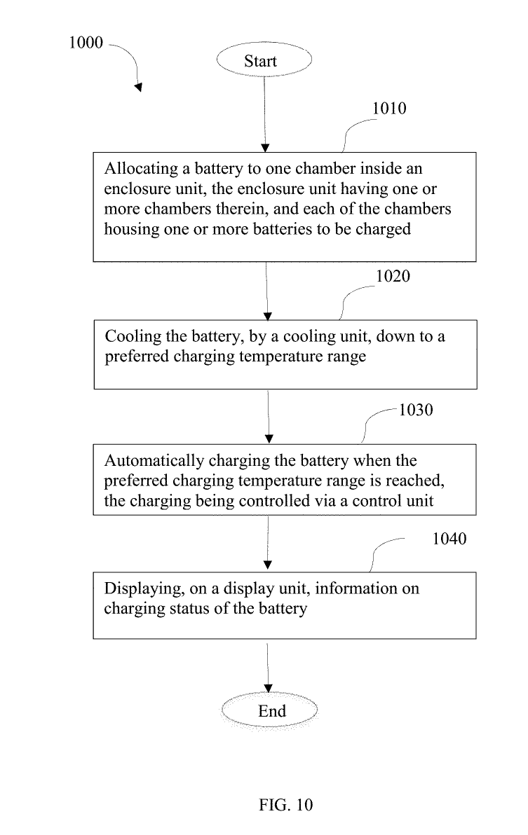

Methods for charging a battery are also provided in this disclosure. FIG. 10 illustrates an example method 1000 for charging a battery. The method 1000 may be implemented in the above described system and may include the following steps.

In step 1010, a battery is allocated to one chamber inside an enclosure unit, such as the enclosure 102. As described above, the enclosure unit may have one or more chambers therein, and each of the chambers may house one or more batteries to be charged.

In step 1020, the battery is cooled, by a cooling unit 108, down to a preferred charging temperature range.

In step 1030, the battery is automatically charged when the preferred charging temperature range is reached. The charging can be controlled via a control unit.

In step 1040, information on charging status of the battery is displayed on a display unit, such as the display unit 106. The control unit is in communication with the display unit to provide the information on the charging status.

In some embodiments, the method 1000 may also include automatically controlling and shutting off coolant delivery to the one chamber when the preferred charging temperature range of the battery inside the one chamber is reached.

In some embodiments, the method 1000 may further include automatically controlling and shutting off charging the battery when the battery reach a maximum capacity.

In some embodiments, battery charging can be optimized based on a profile of the battery. The profile may include one or more of: a present maximum capacity of the battery, the number that the battery has been charged, a preferred charging rate specified from a manufacturer of the battery, a preferred charging electric current specified from the manufacturer of the battery, and a preferred charging electric voltage specified from the manufacturer of the battery.

The profile and other information may be monitored and displayed on a display panel. The display panel, such as the display unit 106, may be integrated to the front of the enclosure such that the chambers are not required to be opened to check on with the battery inside. The batteries, the battery temperatures, the battery charge, and other information may be monitored and displayed. Based on the monitoring, the battery charging can be controlled, for example, charging can be started at a particular time. Status information on recharge capacity, and information on temperatures may be displayed for each zone.

In some embodiments, battery charging may be balanced over a given time. For example, lithium polymer batteries may charge up to 90% of their maximum capacities, then balance their different ports and different parts therein, and then charge from that 90% to 100% of their maximum capacities. During this process, if the batteries are too hot to be charged, charging is stopped or reduced before the batteries are cooled down. That is, batteries may be charged only within a given threshold of temperature. After levelling out, the last 10% capacity can be charged and then charging is automatically shut off.

In some embodiments, charging may be optimized based on the ongoing conditions and information, such that the charging may be sped up or slowed down. For example, the amount of amperage that can be pushed through to the batteries can depend on the current temperature of the batteries, which can be raised up or brought down to various points based on the current temperature. To optimize the charging (e.g., speeding up the charge process), the charging parameters may also include the charge rate based on the observable conditions in addition to the profile of the battery type that's being charged.

The optimizing parameters may also include the age of the battery and the usage of the battery. For example, every time the battery is charged and every time the battery is used, and the amount of time that the battery has been in use all shall be tracked and monitored, as they play a factor into recharging of the battery. Specifically, the number of cycles that a given battery is used is tracked, and the type of the battery is identified. The system can infer the maximum capacity that battery should be holding, the current capacity of the battery, and the charge that the battery is actually holding. A degradation degree of the battery at that point may be determined, which can be used to determine when the battery needs to be replenished, changed out, or swapped out.

A battery may be further optimized for its intended use. For example, based on an assignment that a battery will perform, a charge rate of the battery, and a usage rate of the battery, it might be acceptable for an older battery to be recharged if it's going to be used in lightweight tasks. Whereas a newer battery may be needed if a more aggressive task is going to be performed, such as a long-range task versus a short-range task for a drone delivery. Such information may also be dated and streamed to a command and control center. In such a way, it can be known exactly when a battery is going to be available, and when the battery needs to be paired with a given task, making drone delivery more efficient.

In some embodiments, the profile of a battery can be managed by a central computer, for example a server, where the profile may initially be provided with the characteristics provided by the manufacturer of the battery. The tasks that the battery has performed and historical information of the battery are used to build the profile. Thus, the profile can be derived from the manufacturer's data and the utilization history of the battery (e.g., how many times the battery has been charged and recharged).

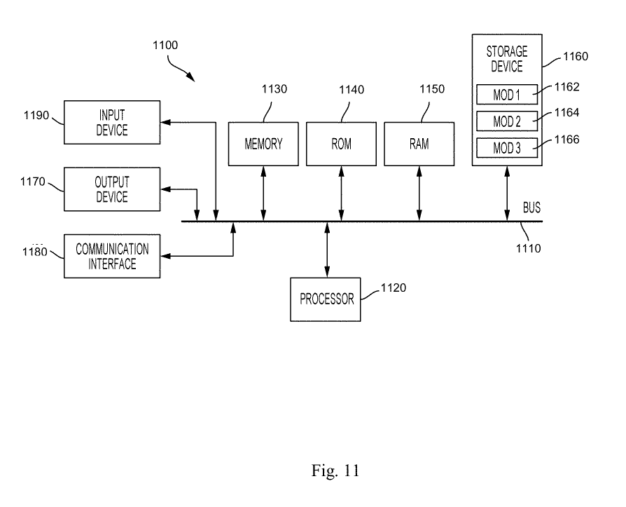

FIG. 11 illustrates an example computer system 1100 which can be used to perform the systems for inventory monitoring as disclosed herein. The exemplary system 1100 can include a processing unit (CPU or processor) 1120 and a system bus 1110 that couples various system components including the system memory 1130 such as read only memory (ROM) 1140 and random access memory (RAM) 11110 to the processor 1120. The system 1100 can include a cache of high speed memory connected directly with, in close proximity to, or integrated as part of the processor 1120. The system 1100 copies data from the memory 1130 and/or the storage device 1160 to the cache for quick access by the processor 1120. In this way, the cache provides a performance boost that avoids processor 1120 delays while waiting for data. These and other modules can control or be configured to control the processor 1120 to perform various actions. Other system memory 1130 may be available for use as well. The memory 1130 can include multiple different types of memory with different performance characteristics. It can be appreciated that the disclosure may operate on a computing device 1100 with more than one processor 1120 or on a group or cluster of computing devices networked together to provide greater processing capability. The processor 1120 can include any general purpose processor and a hardware module or software module, such as module 1 1162, module 2 1164, and module 3 1166 stored in storage device 1160, configured to control the processor 1120 as well as a special-purpose processor where software instructions are incorporated into the actual processor design. The processor 1120 may essentially be a completely self-contained computing system, containing multiple cores or processors, a bus, memory controller, cache, etc. A multi-core processor may be symmetric or asymmetric.

The system bus 1110 may be any of several types of bus structures including a memory bus or memory controller, a peripheral bus, and a local bus using any of a variety of bus architectures. A basic input/output (BIOS) stored in ROM 1140 or the like, may provide the basic routine that helps to transfer information between elements within the computing device 1100, such as during start-up. The computing device 1100 further includes storage devices 1160 such as a hard disk drive, a magnetic disk drive, an optical disk drive, tape drive or the like. The storage device 1160 can include software modules 1162, 1164, 1166 for controlling the processor 1120. Other hardware or software modules are contemplated. The storage device 1160 is connected to the system bus 1110 by a drive interface. The drives and the associated computer-readable storage media provide nonvolatile storage of computer-readable instructions, data structures, program modules and other data for the computing device 1100. In one aspect, a hardware module that performs a particular function includes the software component stored in a tangible computer-readable storage medium in connection with the necessary hardware components, such as the processor 1120, bus 1110, display 1170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 1100 is a small, handheld computing device, a desktop computer, or a computer server.

Although the exemplary embodiment described herein employs the hard disk 1160, other types of computer-readable media which can store data that are accessible by a computer, such as magnetic cassettes, flash memory cards, digital versatile disks, cartridges, random access memories (RAMs) 11110, and read only memory (ROM) 1140, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 1100, an input device 1190 represents any number of input mechanisms, such as a microphone for speech, a touch-sensitive screen for gesture or graphical input, keyboard, mouse, motion input, speech and so forth. An output device 1170 can also be one or more of a number of output mechanisms known to those of skill in the art. In some instances, multimodal systems enable a user to provide multiple types of input to communicate with the computing device 1100. The communications interface 1180 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A battery charging system, comprising:
an enclosure unit having one or more chambers therein, wherein each of the chambers houses one or more batteries to be charged; each of the chambers includes a modular connection that connects to charging ports of the batteries; and the modular connection is interchangeable for different battery connectors;
a power supply connected to the modular connection;
a cooling unit configured to cool down the batteries to a charging temperature range, the cooling unit in fluid communication with the enclosure unit;
a display unit configured to display information on charging status of the batteries, the display unit being on an outside of the enclosure unit; and
a control unit configured to automatically control charging of the batteries, the control unit being in communication with the power supply and the display unit to provide the information on the charging status, and the control unit receiving parameters of the batteries and charging parameters to determine charging time of the batteries.

2. The battery charging system of claim 1, wherein the chambers are zoned such that the charging of the batteries is separately controlled.

3. The battery charging system of claim 1, wherein the battery charging is optimized based on a profile of the battery, the profile including at least one of: a present maximum capacity of the battery, the number that the battery has been charged, a charging rate, a charging electric current, and a charging electric voltage.

4. The battery charging system of claim 1, further comprising a ducting including one or more ducts respectively connected to the one or more chambers.

5. The battery charging system of claim 1, wherein the cooling unit includes at least one coolant of: gas, liquid, or a combination thereof.

6. The battery charging system of claim 5, wherein the gas coolant is air and the liquid coolant is water.

7. The battery charging system of claim 1, wherein each of the chambers includes a cooling plate configured in communication with the batteries to facilitate cooling the batteries to the charging temperature.

8. The battery charging system of claim 1, wherein the control unit is further configured to automatically shut off coolant delivery from the cooling unit to the chambers when the preferred charging temperature range is reached.

9. The battery charging system of claim 1, wherein the control unit is further configured to automatically shut off charging the batteries when the batteries reach maximum capacities.

10. The battery charging system of claim 1, wherein the control unit is further configured to control a flow rate of coolant from the cooling unit going into each of the chambers.

11. The battery charging system of claim 1, wherein the information on the charging status includes a charging rate, how long a battery has been charged, how much capacity of the battery has been charged, a voltage and an amperage charging the battery, a current temperature of the battery, and an expected time for fully charging the battery.

12. The battery charging system of claim 1, wherein the display unit is further configured to display information on the batteries, the information on the batteries including a maximum capacity of the battery, a charging rate, a charging temperature, and a degraded degree of the battery.

13. The battery charging system of claim 1, further comprising a binary language unit that convert the information on the charging status into a binary code.

14. The battery charging system of claim 13, wherein the control unit is further configured to perform battery charging computing based on the binary code.

15. The battery charging system of claim 13, wherein the binary language unit is further configured to facilitate controlling and monitoring the charging and cooling process of the batteries.

16. The battery charging system of claim 13, wherein the binary language unit is further configured to facilitate displaying on the display unit the information on the charging status and other information on the batteries.

17. The batter charging system of claim 13, the binary language unit is further configured to perform battery cooling computing based on the binary code.

18. A method of charging a battery, comprising:
allocating the battery to a chamber inside an enclosure unit, the enclosure unit having one or more of the chambers therein, and each of the chambers having a modular connection;
connecting the battery to the modular connection
receiving parameters of the battery and charging parameters at a control unit via the modular connection;
cooling the battery based on the parameters of the battery, by a cooling unit, down to a preferred charging temperature range;
automatically starting charging the battery based on the parameters of the battery and the charging parameters, when the preferred charging temperature range is reached, the charging being controlled via a control unit;
optimizing the charging of the battery based on optimizing parameters via the control unit; and
displaying, on a display unit, information on charging status of the battery,
wherein the control unit monitors the charging of the battery, and is in communication with the display unit to provide the information on the charging status.

19. The method of claim 18, further comprising:
automatically shutting off coolant delivery to the one chamber when the preferred charging temperature range is reached.

20. The method of claim 18, further comprising:
receiving usage requirements of the battery;
determining a capability of charging the battery to meet the usage requirements based on the parameters of the battery and the charging parameters of the battery;
generating a confidence level with a non-negative number when the capability of charging the battery meets the usage requirements of the battery; and
generating a confidence level with a negative number when the capability of charging the battery does not meet the usage requirements of the battery.
